(19) United States
(12) Patent Application Publication
(10) Pub. No.: US 2025/0190348 A1
(43) Pub. Date: Jun. 12, 2025

(54) PROCESSOR AND ELECTRONIC DEVICE INCLUDING THE SAME

(71) Applicant: Samsung Electronics Co., Ltd., Suwon-si (KR)

(72) Inventor: Kil Ho LEE, Suwon-si (KR)

(73) Assignee: Samsung Electronics Co., Ltd., Suwon-si (KR)

(21) Appl. No.: 18/797,046

(22) Filed: Aug. 7, 2024

(30) Foreign Application Priority Data
Dec. 6, 2023 (KR) 10-2023-0175334

(51) Int. Cl. G06F 12/0811; G06F 13/16

(52) U.S. Cl. CPC G06F 12/0811; G06F 13/1657; G06F 13/1668

(57) ABSTRACT

A processor and an electronic device including the same are provided. The processor includes a first cache including a first cell array and a first peripheral circuit, the first peripheral circuit being electrically connected to the first cell array; and a second cache including a second cell array and a second peripheral circuit, the second peripheral circuit being electrically connected to the second cell array and different from the first peripheral circuit, each of the first cell array and the second cell array including magnetic random-access memory (MRAM) cells.

### CROSS-REFERENCE TO RELATED APPLICATION

This application claims priority from Korean Patent Application No. 10-2023-0175334 filed on Dec. 6, 2023, in the Korean Intellectual Property Office, and all the benefits accruing therefrom under 35 U.S.C. 119, the contents of which in its entirety are herein incorporated by reference.

### BACKGROUND

The present inventive concepts relate to processors and electronic devices including the processors.

As electronic devices become faster and more power-efficient, memory devices embedded in the electronic devices are also required to have fast read/write operations and low operating voltages. Magnetic memory devices are being researched as memory devices that meet these requirements. Magnetic memory devices are non-volatile and capable of performing high-speed operations, making them prominent as the next-generation memory devices.

Meanwhile, as magnetic memory devices become increasingly integrated, spin transfer torque-magnetic random-access memories (STT-MRAMs), which store information using the spin transfer torque (STT) phenomenon, are being studied. STT-MRAMs store information by inducing magnetization reversal through the direct application of currents to magnetic tunnel junction elements. Highly integrated STT-MRAMs require high-speed operations and low current operations.

### SUMMARY

Some example embodiments provide a processor containing a cache that is a magnetic random-access memory (MRAM).

Some example embodiments provide an electronic device that includes a processor containing a cache that is an MRAM.

However, the inventive concepts are not restricted to those set forth herein. The above and example embodiments of the present inventive concepts will become more apparent to one of ordinary skill in the art to which the present inventive concepts pertain by referencing the detailed description of the present disclosure given below.

According to some example embodiments, there is provided a processor including a first cache including a first cell array and a first peripheral circuit, the first peripheral circuit being electrically connected to the first cell array; and a second cache including a second cell array and a second peripheral circuit, the second peripheral circuit being electrically connected to the second cell array and different from the first peripheral circuit, each of the first cell array and the second cell array including magnetic random-access memory (MRAM) cells.

According some example embodiments, a processor including at least one core; and a cache memory including L1, L2, and L3 caches and a first cache, each of the L3 cache and the first cache including magnetic random-access memory (MRAM) cells, and the at least one core configured to access the L3 cache before accessing the first cache.

According to some example embodiments, an electronic device including a processor including at least one central processor and first and second caches, each of the first cache and the second cache including magnetic random-access memory (MRAM) cells and a peripheral circuit; and a main memory configured to communicate with the processor.

It should be noted that the example embodiments of the present inventive concepts are not limited to those described above, and other example embodiments of the present inventive concepts will be apparent from the following description.

### BRIEF DESCRIPTION OF THE DRAWINGS

The above and other aspects and features of the present inventive concepts will become more apparent by describing in detail exemplary embodiments thereof with reference to the attached drawings, in which:

FIG. 1 is a block diagram of an electronic device according to some example embodiments;

FIG. 2 is a schematic diagram of a memory according to some example embodiments;

FIG. 3 is a schematic diagram of a memory cell array of FIG. 2 according to some example embodiments;

FIG. 4 is a block diagram for explaining an operation of the electronic device of FIG. 1 according to some example embodiments;

FIG. 5 is a circuit diagram for explaining an electronic device according to some example embodiments;

FIG. 6 is a block diagram illustrating the operation of the electronic device of FIG. 1 according to some example embodiments;

FIG. 7 is a block diagram of an electronic device according to some example embodiments;

FIG. 8 is a schematic diagram illustrating a memory hierarchy according to some example embodiments;

FIG. 9 is a block diagram of an electronic device according to some example embodiments;

FIG. 10 is a block diagram of a host-storage system according to some example embodiments;

FIG. 11 is a block diagram of a system to which a processor according to some example embodiments; and

FIG. 12 is a block diagram of a data center to which a processor according to some example embodiments.

### DETAILED DESCRIPTION

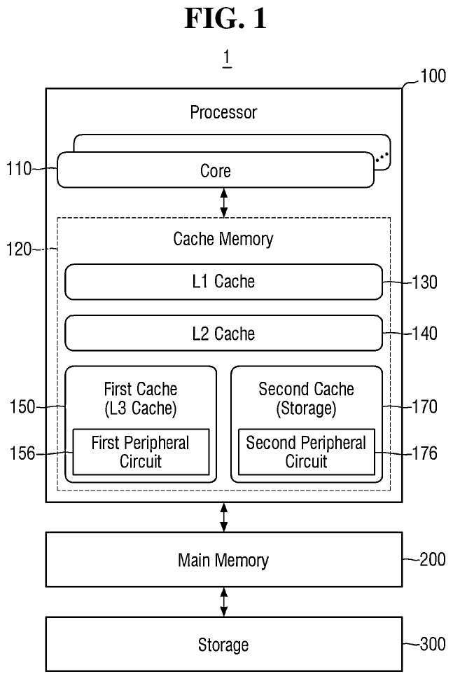

FIG. 1 is a block diagram of an electronic device according to some example embodiments.

Referring to FIG. 1, an electronic device 1 may include a processor 100, a main memory 200, and a storage 300. For example, the electronic device 1 may be a desktop computer, a laptop computer, a workstation, a server, a mobile device, etc., but example embodiments are not limited thereto.

The processor 100 may control the overall operation of the electronic device 1, for example, the operation of the other components of the electronic device 1, such as hardware or software components. The processor 100 may be implemented as a general-purpose processor, a dedicated processor, or an application processor.

The processor 100 includes at least one core 110 and a cache memory 120. According to some example embodiments, the processor 100 may further include other intellectual property (IP) elements (e.g., a memory controller), a system bus, etc. The core 110 and the cache memory 120 may communicate through the system bus. The system bus may include, for example, a data bus, an address bus, or a control bus.

For example, the core 110 and the cache memory 120 may be disposed on the same semiconductor chip. The processor 100 may be implemented as a System-on-Chip (SoC).

The core 110 executes software (e.g., application programs, operating systems, device drivers, etc.) to be performed on the electronic device 1. The core 110 may run an operating system (OS) loaded into the main memory 200. The core 110 may execute various application programs that operate based on the OS.

The processor 100 includes at least one core 110. The processor 100 may include at least one homogeneous or heterogenous core 110. The core 110 may be referred to as a central processing unit (CPU).

The cache memory 120 may communicate with the core 110. The cache memory 120 may be dedicated to one core 110 or shared by various cores 110.

The cache memory 120 includes a plurality of caches. For example, the cache memory 120 may include an L1 cache 130, an L2 cache 140, a first cache 150, and a second cache 170.

The L1 cache 130 and the L2 cache 140 may be static random-access memories (SRAMs). Each of the L1 cache 130 and the L2 cache 140 may include a cell array containing SRAM memory cells and a peripheral circuit electrically connected to the cell array.

For example, the L1 cache 130 and the L2 cache 140 may be disposed or located on the outside of the core 110. In some example embodiments, the L1 cache 130 and/or the L2 cache 140 may be included in the core 110.

The first cache 150 is an L3 cache. The first cache 150 may include different types of memory cells than the L1 cache 130 and the L2 cache 140. The first cache 150 may be an MRAM. The first cache 150 includes a cell array containing MRAM memory cells, and a first peripheral circuit 156, which is electrically connected to the cell array.

The second cache 170 may include different types of memory cells than the L1 cache 130 and the L2 cache 140. The second cache 170 may include memory cells of the same type as the first cache 150. The second cache 170 may be an MRAM. The second cache 170 includes a cell array containing MRAM cells, and a second peripheral circuit 176, which is different from the first peripheral circuit 156 and electrically connected to the cell array. Thus, the first and second caches 150 and 170 include different peripheral circuits, e.g., the first and second peripheral circuits 156 and 176, respectively.

The second cache 170 has different characteristics than the first cache 150. According to some example embodiments, the characteristics may include speed, retention period, capacity, etc. For example, the second cache 170 may have a different speed and/or retention period than the first cache 150. Here, the speed may refer to, for example, the speed of reading and/or writing data. For example, the read speed of the second cache 170 may be slower than the read speed of the first cache 150, and the retention period of the second cache 170 may be longer than the retention period of the first cache 150.

The first and second caches 150 and 170 are disposed or located on the same semiconductor chip.

The main memory 200 may communicate with the processor 100. The main memory 200 may have, for example, a relatively large storage capacity compared to the cache memory 120. The main memory 200 may be, for example, a dynamic random-access memory (DRAM).

The main memory 200 may be a working memory. Application programs or an operating system (OS) may be loaded into the main memory 200 during booting.

In some example embodiments, the storage 300 may store programs (e.g., at least part of the OS) for turning on and/or booting the electronic device 1. For example, during the booting of the electronic device 1, an OS image stored in the storage 300 may be loaded into the main memory 200 according to a boot sequence. The core 110 may run the OS loaded into the main memory 200. The OS may support various input/output operations of the electronic device 1. Similarly, in some example embodiments, application programs may be loaded into the main memory 200 either by user selection or for providing basic services.

The storage 300 may communicate with the processor 100. The storage 300 may be, for example, a solid-state drive (SSD).

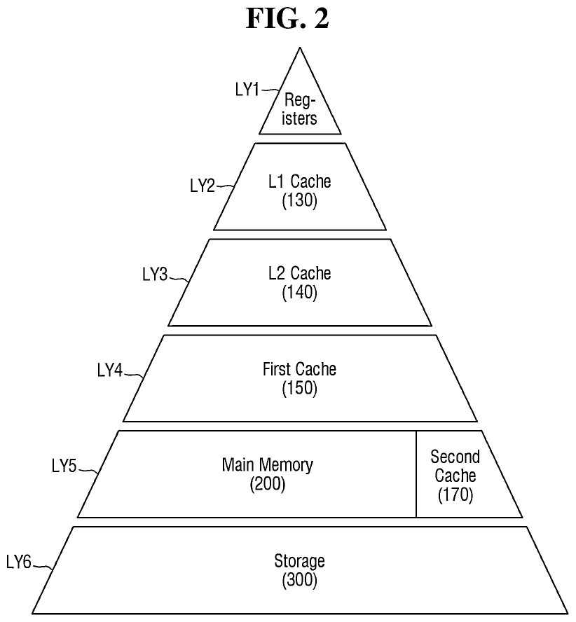

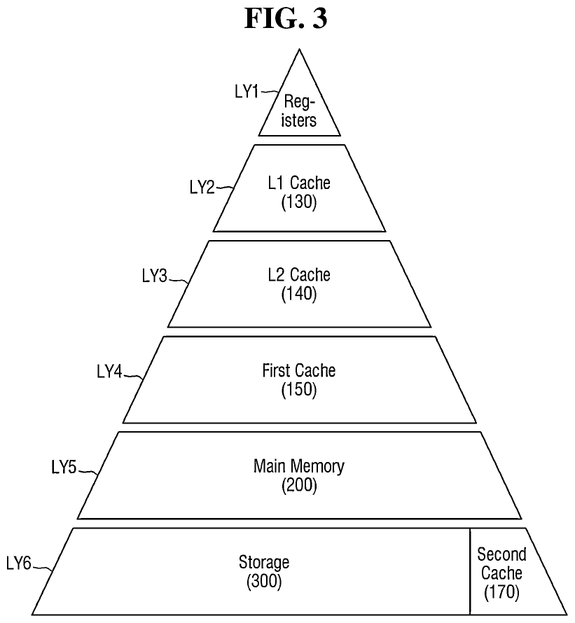

FIGS. 2 and 3 are schematic diagrams illustrating memory hierarchies according to some example embodiments. The memory hierarchy may correspond to the electronic device 1 of FIG. 1. The memory hierarchy may have the form of a pyramid.

Referring to FIGS. 1 through 3, the memory hierarchy may include a first layer LY1, a second layer LY2, a third layer LY3, a fourth layer LY4, a fifth layer LY5, and a sixth layer LY6. For convenience of description, the closer to the first layer LY1, the higher the level of each layer, and the closer to the sixth layer LY6, the lower the level of each layer. In some example embodiments, the higher the level of each layer, the more frequent the access to a corresponding memory, the faster the data input/output speed, the higher the manufacturing cost, and the smaller the storage capacity.

The first layer LY1 may be the layer of CPU registers. For example, the first layer LY1 may correspond to the registers of one or more cores 110.

The second, third, and fourth layers LY2, LY3, and LY4 may be cache memory layers. For example, the second, third, and fourth layers LY2, LY3, and LY4 may correspond to the L1 cache 130, the L2 cache 140, and the first cache 150, respectively.

The fifth layer LY5 may correspond to the main memory 200.

The sixth layer LY6 may correspond to the storage 300.

In some example embodiments, all data stored in a memory from a higher-level layer may be included in a memory from a lower-level layer. For example, the core 110 may sequentially access the L1 cache 130, the L2 cache 140, the first cache 150, the main memory 200, and the storage 300.

In some example embodiments, the second cache 170 may replace part of the main memory 200 and/or part of the storage 300.

Referring to FIG. 2, the fifth layer LY5 may correspond to the main memory 200 and the second cache 170.

The second cache 170 may replace part of the main memory 200. A fifth layer LY5 of a conventional memory hierarchies may include only the main memory 200. The second cache 170 may store some of the data stored in the main memory 200. In other words, the second cache 170 and the main memory 200 may perform the functions of a conventional main memory. The core 110 may access the first cache 150 before accessing the second cache 170.

For example, the second cache 170 may store data with a relatively higher access frequency from among data stored in a conventional main memory. The core 110 may access the second cache 170 before accessing the main memory 200. In some example embodiments, the core 110 may access the main memory 200 before accessing the second cache 170.

Referring to FIG. 3, the sixth layer LY6 may correspond to the storage 300 and the second cache 170.

The second cache 170 may replace a storage 300. A conventional sixth layer LY6 may include only the storage 300. In some example embodiments, the second cache 170 may store some of data stored in the storage 300. For example, the second cache 170 and the storage 300 may perform the functions of a conventional storage. The core 110 may access the first cache 150 before accessing the second cache 170.

For example, the second cache 170 may store data that is accessed more frequently among the data stored in the traditional storage. The core 110 may access the second cache 170 before accessing the storage 300.

Referring again to FIGS. 1 through 3, MRAMs have less leakage current and are smaller in size than SRAMs. The L3 cache 150 has a longer idle time than the L1 cache 130 and the L2 cache 140. The processor 100 includes the L3 cache 150, which includes an MRAM. Therefore, in some example embodiments, an L3 cache 150 with reduced leakage current and greater capacity in a smaller area can be provided.

Moreover, MRAMs have excellent tunability. For example, when implementing the L3 cache 150 with an MRAM, the area occupied by the L3 cache 150 on a semiconductor chip decreases, and as a result, at least one cache (e.g., the second cache 170) with desired characteristics can be provided in the remaining space by adjusting the characteristics of the MRAM. The characteristics of the MRAM may be adjusted in various manners. The number of caches (150 and 170) including MRAMs may vary.

In the processor 100, the second cache 170 may replace part of the main memory 200 and/or part of the storage 300. Therefore, the core 110 may access data from the second cache 170 without needing to access the main memory 200 and/or the storage 300. Thus, the cache hit ratio can be improved. In some example embodiments, as the movement of data decreases, the speed and power consumption of the electronic device 1 can be improved.

In some example embodiments, in the processor 100, the first and second caches 150 and 170 may not share peripheral circuits and may include the first and second peripheral circuits 156 and 176, respectively. Therefore, the placement of the first and second caches 150 and 170 on the semiconductor chip may be flexible. For example, the first and second caches 150 and 170 may be adjacent to each other on the semiconductor chip, and the L1 and L2 caches 130 and 140 may be disposed on the first and second caches 150 and 170, respectively.

In some example embodiments, the first and second peripheral circuits 156 and 176 may be freely designed according to the characteristics of the first and second caches 150 and 170, respectively.

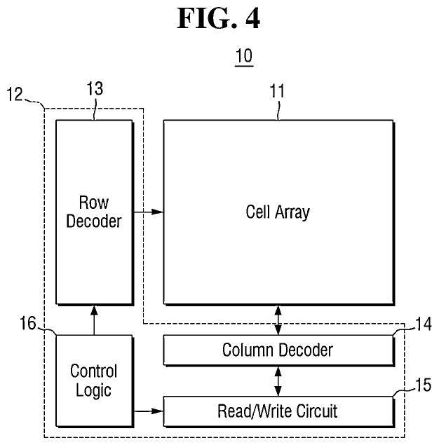

FIG. 4 is a block diagram of a memory according to some example embodiments.

Referring to FIG. 4, a memory 10 may include a cell array 11 and a peripheral circuit 12. The peripheral circuit 12 includes a row decoder 13, a column decoder 14, a read/write circuit 15, and control logic 16. The peripheral circuit 12 is electrically connected to the cell array 11.

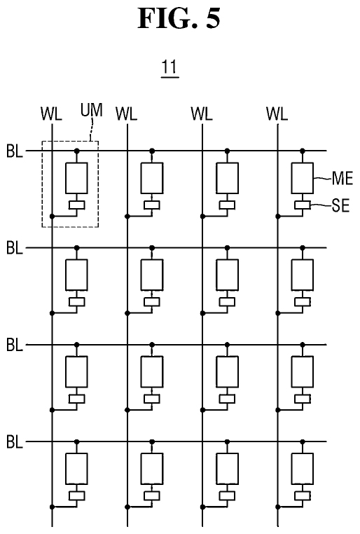

The cell array 11 may include a plurality of wordlines and a plurality of bitlines (not shown). Memory cells may be connected at the intersections of the wordlines and bitlines. The cell array 11, according to some example embodiments, will be described later in detail with reference to FIG. 5.

The row decoder 13 may be connected to the cell array 11 through the wordlines. The row decoder 13 may decode an address input from the outside and select one of the wordlines.

The column decoder 14 may be connected to the cell array 11 through the bitlines. The column decoder 14 may decode the input address and select one of the bitlines. The bitline selected by the column decoder 14 may be connected to the read/write circuit 15.

The read/write circuit 15 may provide a bitline bias for accessing a selected memory cell, under the control of the control logic 16. For example, the read/write circuit 15 may provide a bitline bias to the selected bitline to write input data to or read data from the selected memory cell.

The control logic 16 may output control signals to control the memory 10 in accordance with a command signal provided thereto from the outside. The control signal output from the control logic 16 may control the read/write circuit 15.

FIG. 5 is a circuit diagram of the cell array of FIG. 4 according to some example embodiments.

Referring to FIGS. 4 and 5, the cell array 11 may include a plurality of bitlines BL, a plurality of wordlines WL, and a plurality of memory cells UM. The memory cells UM may be MRAM cells.

The wordlines WL may extend in a first direction. The bitlines BL may extend in a second direction, which crosses (e.g., perpendicular) the first direction, and may intersect the wordlines WL.

The memory cells UM may be arranged two-dimensionally or three-dimensionally. The memory cells UM may be connected at the intersections of the wordlines WL and bitlines BL. Accordingly, in some example embodiments, the memory cells UM, connected to the wordlines WL, may be connected to the read/write circuit 15 of FIG. 4 by the bitlines BL. The memory cells UM may include magnetic tunnel junction devices ME and selection devices SE.

In some example embodiments, magnetic tunnel junction devices ME may be connected between the bitlines BL and the selection devices SE, and the selection devices SE may be connected between the magnetic tunnel junction devices ME and the wordlines WL. Each of the magnetic tunnel junction devices ME may include a reference layer, a free layer, and a tunnel barrier layer.

In some example embodiments, selection devices SE may be configured to selectively control the flow of charge passing through the magnetic tunnel junction devices ME. For example, each of the selection devices SE may include at least one of a diode, a PNP bipolar transistor, an NPN bipolar transistor, an N-type metal-oxide semiconductor (NMOS) field-effect transistor (FET), and a P-type metal-oxide semiconductor (PMOS) FET. If the selection devices SE are three-terminal devices such as bipolar transistors or metal-oxide semiconductor (MOS) FETs, additional wiring (e.g., source lines) may be connected to the selection devices SE.

The memory 10 of FIG. 4 may correspond to each of the first and second caches 150 and 170 of FIG. 1. The first cache 150 of FIG. 1 includes a first cell array containing first memory cells and the first peripheral circuit 156 electrically connected to the first cell array. The cell array 11 and the peripheral circuit 12 of FIG. 4 may correspond to the first cell array and the first peripheral circuit 156, respectively, of FIG. 1. The first memory cells may correspond to the memory cells UM of FIG. 5. The second cache 170 of FIG. 1 includes a second cell array containing second memory cells and the second peripheral circuit 176 electrically connected to the second cell array. The cell array 11 and the peripheral circuit 12 of FIG. 4 may correspond to the second cell array and the second peripheral circuit 176, respectively, of FIG. 1. The second memory cells may correspond to the memory cells UM of FIG. 5.

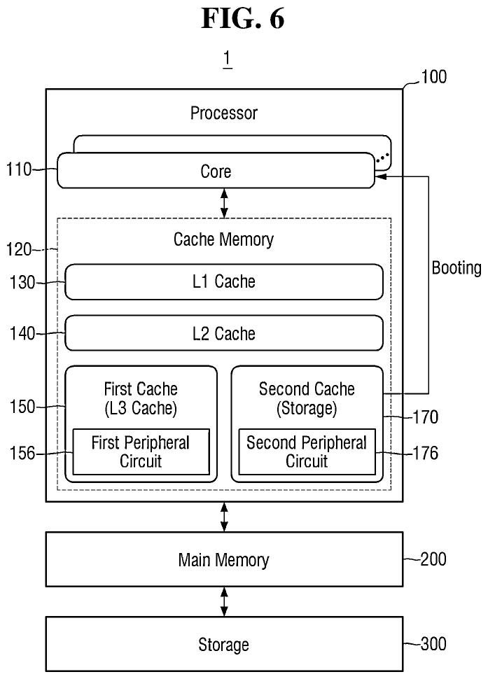

FIG. 6 is a block diagram illustrating the operation of the electronic device of FIG. 1 according to some example embodiments.

Referring to FIG. 6, in some example embodiments, the second cache 170 may store programs (e.g., at least part of the OS) for turning on and/or booting the electronic device 1. For example, during the booting of the electronic device 1, an OS image stored in the second cache 170 may be loaded into the main memory 200 according to the boot sequence. The core 110 may run the OS loaded into the main memory 200. Therefore, the boot time of the electronic device 1 can be reduced.

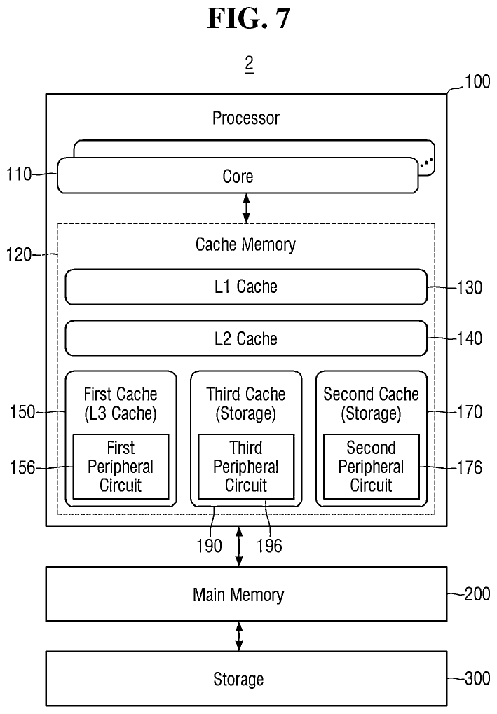

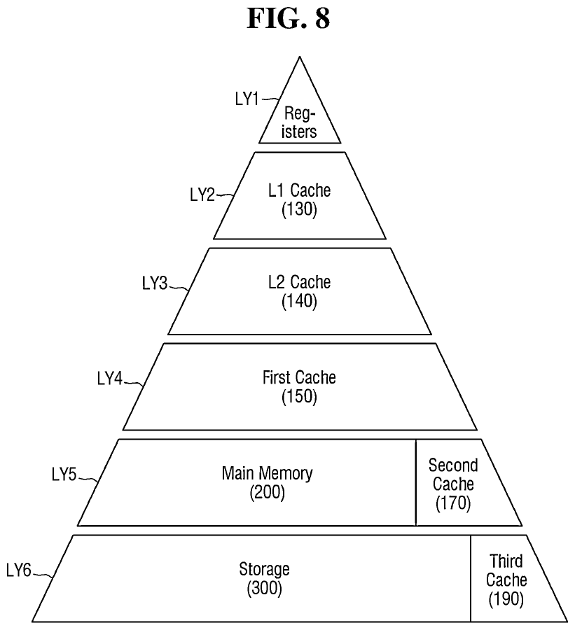

FIG. 7 is a block diagram of an electronic device according to some example embodiments. FIG. 8 is a schematic diagram illustrating a memory hierarchy according to some example embodiments. The memory hierarchy of FIG. 8 may correspond to an electronic device 2 of FIG. 7. For convenience, descriptions overlapping with what has been described above with FIGS. 1 through 6 will be briefly explained or omitted.

Referring to FIG. 7, a cache memory 120 includes first and second caches 150 and 170 and may include a third cache 190.

The third cache 190 may be an MRAM. The third cache 190 includes a cell array containing MRAM cells and a third peripheral circuit 196 electrically connected to the cell array. The third peripheral circuit 196 is different from first and second peripheral circuits 156 and 176 of the first and second caches 150 and 170. For example, the first, second, and third caches 150, 170, and 190 include different peripheral circuits, e.g., the first, second, and third peripheral circuits 156, 176, and 196, respectively.

The third cache 190 may have different characteristics from the first and second caches 150 and 170. For example, the third cache 190 may have a different speed and/or retention period than the second cache 170. For example, the read speed of the third cache 190 may be slower than the read speed of the second cache 170, and the retention period of the third cache 190 may be longer than the retention period of the second cache 170.

The first, second, and third caches 150, 170, and 190 are disposed on the same semiconductor chip. The third cache 190 includes a third cell array containing third memory cells and a third peripheral circuit 196 electrically connected to the third cell array. The cell array 11 and the peripheral circuit 12 of FIG. 4 may correspond to the third cell array and the third peripheral circuit 196, respectively, of FIG. 7. The third memory cells may correspond to the memory cells UM of FIG. 5.

Referring to FIGS. 7 and 8, the fifth layer LY5 may correspond to a main memory 200 and the second cache 170. The sixth layer LY6 may correspond to the storage 300 and the third cache 190. The second cache 170 of FIGS. 6 and 7 may correspond to the second cache 170 of FIGS. 1 and 2. The third cache 190 of FIGS. 6 and 7 may correspond to the second cache 170 of FIGS. 1 and 3.

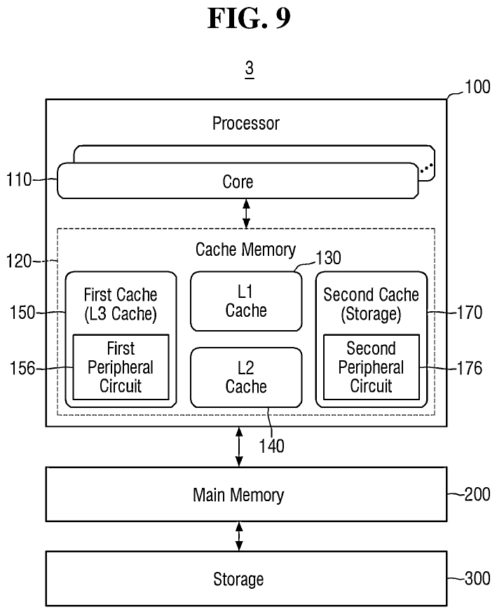

FIG. 9 is a block diagram of an electronic device according to some example embodiments. For convenience, descriptions overlapping with what has been described above with FIGS. 1 through 6 will be briefly explained or omitted.

Referring to FIG. 9, in a processor 100, an L1 cache 130 and an L2 cache 140 may be disposed on a semiconductor chip between the first cache 150 and the second cache 170.

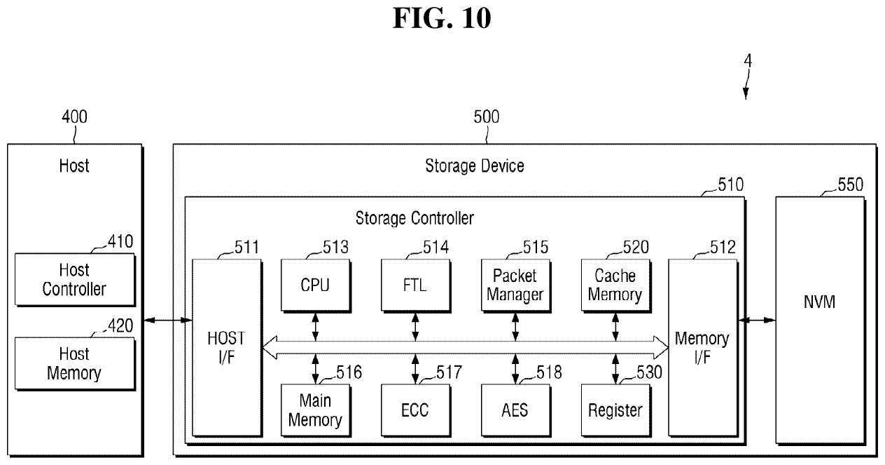

FIG. 10 is a block diagram illustrating a host-storage system according to some example embodiments.

Referring to FIG. 10, a host-storage system 4 may include a host 400 and a storage device 500. The storage device 500 may also include a storage controller 510 and a non-volatile memory 550. In some example embodiments, the host 400 may include a host controller 410 and a host memory 420. The host memory 420 may function as a buffer memory for temporarily storing data to be transmitted to the storage device 500 or data received from the storage device 500.

The storage device 500 may include storage media for storing data in accordance with a request from the host 400. For example, the storage device 500 may include at least one of an SSD, an embedded memory, and a removable external memory. If the storage device 500 is an SSD, the storage device 500 may be a device following the Non-Volatile Memory Express (NVMe) standard. If the storage device 500 is an embedded or external memory, the storage device 500 may be a device following the Universal Flash Storage (UFS) or embedded Multi-Media Card (eMMC) standard. The host 400 and the storage device 500 may generate and transmit or send packets according to each employed standard protocol.

In some example embodiments, when the nonvolatile memory 550 of the storage device 500 includes a flash memory, the flash memory may include a two-dimensional (2D) NAND memory array or a three-dimensional (3D) NAND (vertical NAND (VNAND)) memory array. Alternatively, in some example embodiments the storage device 500 may include various other types of nonvolatile memories. For example, the storage device 500 may include an MRAM, a spin-transfer torque (STT)-MRAM, a conductive bridging random-access memory RAM (CBRAM), a ferroelectric random-access memory (FeRAM), a phase random-access memory (PRAM), a resistive random-access memory (RRAM), and various other types of memories.

In some example embodiments, the host controller 410 and the host memory 420 may be implemented as separate semiconductor chips. Alternatively, in some example embodiments, the host controller 410 and the host memory 420 may be integrated on the same semiconductor chip. For example, the host controller 410 may be one of several modules included in an application processor, which may be implemented as an SoC. Moreover, in some example embodiments, the host memory 420 may be an embedded memory within the application processor or a non-volatile memory or memory module disposed on the outside of the application processor.

The host controller 410 may manage the operation of storing data (e.g., write data) from a buffer area in the non-volatile memory 550 or storing data (e.g., read data) from the nonvolatile memory 550 (e.g., read data) in the buffer area.

The storage controller 510 may include a host interface 511, a memory interface 512, and a CPU 513. The storage controller 510 may also include a flash translation layer (FTL) 514, a packet manager 515, a main memory 516, an error correction code (ECC) engine 517, an advanced encryption standard (AES) engine 518, a cache memory 520, and a register 530.

In some example embodiments, the storage controller 510 may further include a working memory (not illustrated) where the FTL 514 is loaded, and the CPU 513 may control data write and read operations to the nonvolatile memory 550 by executing the FTL 514.

The host interface 511 may exchange packets with the host 400. Packets transmitted from the host 400 to the host interface 511 may include commands or data to be written to the nonvolatile memory 550, and packets transmitted from the host interface 511 to the host 400 may include responses to commands or data read from the nonvolatile memory 550.

The memory interface 512 may transmit data to be written to the nonvolatile memory 550 or receive data read from the nonvolatile memory 550. The memory interface 512 may be implemented to comply with a standard protocol such as Toggle or ONFI.

The FTL 514 may perform various functions such as address mapping, wear-leveling, garbage collection, etc. Address mapping is the process of converting logical addresses received from the host 400 into physical addresses used for actually storing data in the nonvolatile memory 550. Wear-leveling, which is a technique to prevent excessive degradation of specific blocks in the nonvolatile memory 550 by evenly using the blocks within the nonvolatile memory 550, may be implemented through a firmware technique balancing the erase counts of physical blocks. Garbage collection is a technique to free up capacity within the nonvolatile memory 550 by copying valid data from existing blocks to new blocks and then erasing the existing blocks.

The packet manager 515 may generate packets according to an interface protocol agreed with the host 400 or may parse various information from packets received from the host 400. In some example embodiments, the main memory 516 may temporarily store data to be written to or read from the nonvolatile memory 550. The main memory 516 may be provided within the storage controller 510, but may be disposed on the outside of the storage controller 510. The main memory 516 may also be referred to as a buffer memory.

The ECC engine 517 may perform an error detection and correction function for read data from the nonvolatile memory 550. For example, the ECC engine 517 may generate parity bits for write data to be written to the nonvolatile memory 550, and the generated parity bits may be stored in the nonvolatile memory 550 along with the write data. For example, when reading data from the nonvolatile memory 550, the ECC engine 517 may correct error in the read data use the parity bits read from the nonvolatile memory 550, and may output the error-corrected read data.

The AES engine 518 may perform at least one of encryption and decryption operations on data input to the storage controller 510 using a symmetric-key algorithm.

The cache memory 520 may be the cache memory 120 of any one of FIGS. 1 through 9. For example, the cache memory 120 may include MRAMs as a first cache (“150” of FIGS. 1 through 9) and a second cache (“170” of FIGS. 1 through 9). The first cache 150 may be an L3 cache and may include a first peripheral circuit (“156” of FIGS. 1 through 9), and the second cache 170 may replace part of the main memory 516 or the nonvolatile memory 550.

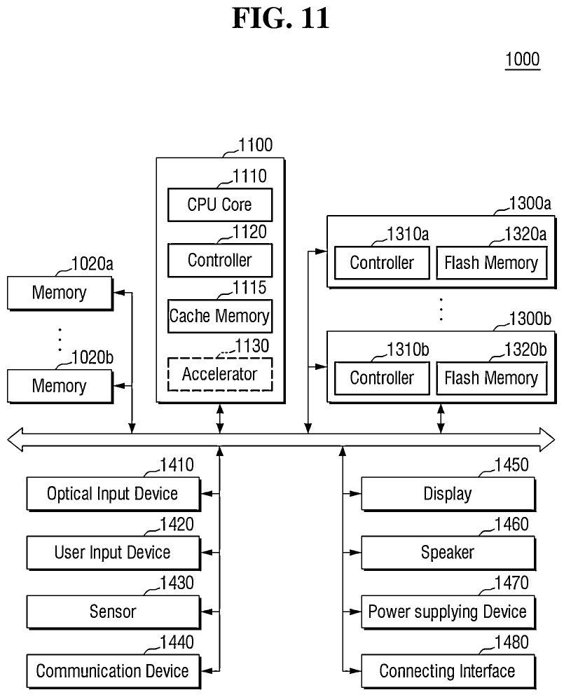

FIG. 11 is a block drawing of a system to which a processor according to some example embodiments is applied.

Referring to FIG. 11, the system 1000 may be a mobile system such as a mobile phone, a smartphone, a tablet personal computer (PC), a wearable device, a healthcare device, or an Internet-of Things (IoT) device, but example embodiments are not limited thereto. According to some example embodiments, the system 1000 may be a PC, a laptop computer, a server, a media player, or navigation equipment in an automotive device.

Referring to FIG. 11, the system 1000 may include a main processor 1100, memories 1020a to 1020b, and storage devices 1300a to 1300b, and may further include at least one of an optical input device 1410 (e.g., an image capturing device), a user input device 1420, a sensor 1430, a communication device 1440, a display 1450, a speaker 1460, a power supplying device 1470, and a connecting interface 1480.

The main processor 1100 may control the overall operation of the system 1000, for example, the operation of the other components of the system 1000. The main processor 1100 may be implemented as a general-purpose processor, a dedicated processor, or an application processor.

The main processor 1100 may include one or more CPU cores 1110 and may further include a controller 1120 to control the memories 1020a to 1020b and/or the storage devices 1300a to 1300b. In some example embodiments, the main processor 1100 may include an accelerator 1130, which may be a dedicated circuit for high-speed data operations such as artificial intelligence (AI) data operations. The accelerator 1130 may include a graphics processing unit (GPU), a neural processing unit (NPU), and/or a data processing unit (DPU), and may be implemented as a physically separate chip independent from the other components of the main processor 1100. For example, the accelerator 1130 may be implemented as processing circuitry such as hardware (e.g., logic circuits) or a combination of hardware and software, such as a computer-based electronic system like a processor executing instruction codes or program routines (e.g., a software program). The instruction codes or the program routines may be stored in any storage device located inside or outside the computer-based electronic system.

The main processor 1100 may include a cache memory 1115. The cache memory 1115 may be the cache memory 120 of any one of FIGS. 1 through 9. For example, the cache memory 120 may include MRAMs as the first and second caches 150 and 170 of any one of FIGS. 1 through 9. The first cache 150 of any one of FIGS. 1 through 9 is an L3 cache and includes the first peripheral circuit 156 of any one of FIGS. 1 through 9, and the second cache 170 of any one of FIGS. 1 through 9 may replace parts of the memories 1200a and 1200b or parts of the storage devices 1300a and 1300b.

The memories 1020a to 1020b may be used as the main memory devices of the system 1000, and may include volatile memories such as SRAMs and/or DRAMs, or non-volatile memories such as flash memories, PRAMs, and/or RRAMs. The memories 1020a to 1020b may also be implemented within the same package as the main processor 1100.

The storage devices 1300a and 1300b may function as non-volatile storage devices that store data regardless of power supply and may have a relatively larger storage capacity compared to the memories 1020a to 1020b. The storage devices 1300a and 1300b may include storage controllers 1310a and 1310b, and nonvolatile memories 1320a and 1320b, which store data under the control of the storage controllers 1310a and 1310b. The nonvolatile memories 1320a and 1320b may include 2D flash memories or 3D VNAND flash memories, but example embodiments are not limited thereto, and may also include other types of nonvolatile memories such as PRAMs and/or RRAMs.

In the system 1000, the storage devices 1300a and 1300b may be physically separate from the main processor 1100 or may be implemented within the same package as the main processor 1100. In some example embodiments, the storage devices 1300a and 1300b may be combined with the system 1000 in a detachable manner similar to that of a memory card through interfaces such as connecting interfaces 1480. The storage devices 1300a and 1300b may be devices applying a standard protocol such as UFS, but example embodiments are not limited thereto.

The optical input device 1410 (e.g., an image capturing device) may capture still images or videos and may be a camera, camcorder, and/or webcam, but example embodiments are not limited thereto.

The user input device 1420 may receive various types of data input from the user of the system 1000, and can be a touchpad, keypad, keyboard, mouse, and/or microphone.

The sensor 1430 may detect various types of physical quantities that can be acquired from the outside of the system 1000 and convert the detected physical quantities into electrical signals. The sensor 1430 may be a temperature sensor, pressure sensor, light sensor, position sensor, acceleration sensor, biosensor, and/or gyroscope.

The communication device 1440 may perform transmission and reception of signals between the system 1000 and other devices outside the system 1000 in accordance with various communication protocols. The communication device 1440 may be implemented to include an antenna, transceiver, and/or modem.

The display 1450 and the speaker 1460 may function as output devices to provide visual and auditory information, respectively, to the user of the system 1000.

The power supply device 1470 may appropriately convert and supply power to the other components of the system 1000 from an embedded battery (not illustrated) and/or an external power source.

The connecting interface 1480 may provide a connection between the system 1000 and an external device that is connected to the system 1000 to exchange data with the system 1000. The connecting interface 1480 may be implemented in various interface formats such as Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVMe, IEEE 1394, Universal Serial Bus (USB), Secure Digital (SD) card, Multi-Media Card (MMC), embedded MMC (eMMC), UFS, embedded UFS (eUFS), Compact Flash (CF) card, etc.

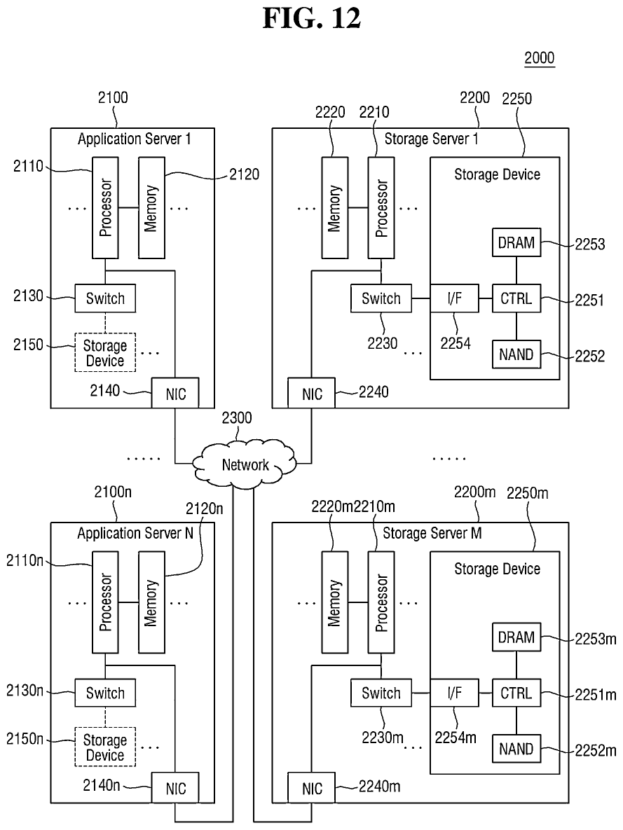

FIG. 12 is a block diagram of a data center to which a processor according to example embodiments is applied.

Referring to FIG. 12, a data center 2000, which may be a facility that collects various data and provides services, may also be referred to as a data storage center. The data center 2000 may be a system for operating search engines and databases and may be used in computing systems for corporations such as banks or government agencies. The data center 2000 may include application servers 2100 through 2100n and storage servers 2200 through 2200m. The numbers of application servers 2100 through 2100n and storage servers 2200 through 2200m may differ from each other and may vary.

The application server 2100 or the storage server 2200 may include at least one processor 2110 or 2210 and a memory 2120 or 2220. The processor 2210 may control the overall operation of the storage server 2200 and may execute instructions and/or data loaded in the memory 2220 by accessing the memory 2220. The memory 2220 may be a double data rate synchronous DRAM (DDR SDRAM), a high-bandwidth memory (HBM), a hybrid memory cube (HMC), a dual in-line memory module (DIMM), an Optane DIMM, or a non-volatile DIMM (NVMDIMM). The numbers of processors 2210 and memories 2220 included in the storage server 2200 may vary.

In some example embodiments, the processor 2210 and the memory 2220 may provide a processor-memory pair. In some example embodiments, the numbers of processors 2210 and memories 2220 may differ from each other. The processor 2210 may include a single-core processor or a multi-core processor. The description of the storage server 2200 may be applicable similarly to the application server 2100. The application server 2100 may not include a storage device 2150. The storage server 2200 may include at least one storage device 2250. The number of storage devices 2250 included in the storage server 2200 may vary.

The processor 2110 or 2210 may be the processor 100 of any one of FIGS. 1 through 9. For example, the processor 2110 or 2210 may include MRAMs as the first and second caches 150 and 170 of any one of FIGS. 1 through 9. The first cache 150 of any one of FIGS. 1 through 9 is an L3 cache and includes the first peripheral circuit 156 of any one of FIGS. 1 through 9, and the second cache 170 of any one of FIGS. 1 through 9 may replace part of the memory 2120 or 2220 or the storage device 2150 or 2250.

The application servers 2100 through 2100n and the storage servers 2200 through 2200m may communicate with one another through a network 2300. The network 2300 may be implemented using Fibre Channel (FC) or Ethernet. FC is a medium used for relatively high-speed data transmission and can utilize high-performance/high-availability optical switches. The storage servers 2200 through 2200m may be provided as file storages, block storages, or object storages depending on how the network 2300 is accessed.

In some example embodiments, the network 2300 may be a storage-specific network such as a storage area network (SAN). For example, the SAN may use an FC network and may be implemented as an FC-SAN according to the FC Protocol (FCP). In some example embodiments, the SAN may use a TCP/IP network and may be implemented as an IP-SAN according to the Small Computer System Interface (SCSI) over Transport Control Protocol/Internet Protocol (TCP/IP) or Internet SCSI (iSCSI) protocol. In some example embodiments, the network 2300 may be a general network such as a TCP/IP network. For example, the network 2300 may be implemented according to a protocol such as FC over Ethernet (FCoE), Network Attached Storage (NAS), or NVMe over Fabrics (NVMe-oF).

The application server 2100 and the storage server 2200 will hereinafter be described. The description of the application server 2100 may also be applicable to the other application servers 2100n, and the description of the storage server 2200 may also be applicable to the other storage servers 2200m.

The application server 2100 may store data requested by a user or client in one of the storage servers 2200 through 2200m via the network 2300. In some example embodiments, the application server 2100 may acquire data requested by a user or client from one of the storage servers 2200 through 2200m through the network 2300. For example, the application server 2100 may be implemented as a web server or a database management system (DBMS).

The application server 2100 may access the memories or storage devices of the other application servers, for example, the memory 2120n or the storage device 2150n included in the application server 2100n, or the memories 2220 through 2220m of storage devices 2250 through 2250m included in the storage servers 2200 through 2200m, through the network 2300. For example, the application server 2100 may perform various operations on data stored in the other application servers and/or in the storage servers 2200 through 2200m. For example, the application server 2100 may execute commands to move or copy data between the application servers 2100 through 2100n and/or the storage servers 2200 through 2200m. In this process, data may be moved from the storage devices 2250 through 2250m of the storage servers 2200 through 2200m through the memories 2220 through 2220m, or directly to the memories 2120 through 2120n of the application servers 2100 through 2100n. The data moved through the network 2300 may be encrypted for security or privacy.

An interface 2254 may provide physical connections between the processor 2210 and a controller 2251, and between a network interface card (NIC) 2240 and the controller 2251. For example, the interface 2254 may be implemented in a direct attached storage (DAS) method, directly connecting the storage device 2250 with a dedicated cable. Additionally, the interface 2254 may be implemented in various interface formats such as ATA, SATA, e-SATA, SCSI, SAS, PCI, PCIe, NVMe, IEEE 1394, USB, SD card, MMC, eMMC, UFS, eUFS, CF card, etc.

The storage server 2200 may further include a switch 2230 and the NIC 2240. The switch 2230 may selectively connect the processor 2210 with the storage device 2250 or connect the NIC 2240 with the storage device 2250 under the control of the processor 2210.

In some example embodiments, the NIC 2240 may include a network interface card, a network adapter, etc. The NIC 2240 may be connected to the network 2300 via a wired interface, a wireless interface, a Bluetooth interface, an optical interface, etc. The NIC 2240 may include an internal memory, a digital signal processor (DSP), a host bus interface, etc., and may be connected to the processor 2210 and/or the switch 2230 via the host bus interface. The host bus interface may be implemented as one of the aforementioned examples of the interface 2254. In some example embodiments, the NIC 2240 may be integrated with at least one of the processor 2210, the switch 2230, or the storage device 2250.

The processors 2110 through 2110n of the application servers 2100 through 2100n or the processors 2210 through 2210m of the storage servers 2200 through 2200m may send commands to storage devices 2130 through 2130n or 2250-2250m, or the memories 2120 through 2120n or 2220 through 2220m to program or read data. Here, the data may be error-corrected data from an Error Correction Code (ECC) engine. The data may be data processed through data bus inversion (DBI) or data masking (DM) and may include cyclic redundancy code (CRC) information. The data may also be data encrypted for security or privacy.

The storage devices 2150 through 2150m or 2250 through 2250m may respond to read commands received from the processors 2110 through 2110n or 2210 through 2210n by transmitting control signals and command/address signals to NAND flash memory devices 2252 through 2252m. Consequently, when reading data from the NAND flash memory devices 2252 through 2252m, read enable (RE) signals are input as data output control signals, enabling data to be output to DQ buses. The RE signals may be used to generate data strobe (DQS) signals. Command and address signals may be latched into page buffers according to the rising or falling edges of write enable (WE) signals.

The controller 2251 may generally control the operation of the storage device 2250. In some example embodiments, the controller 2251 may include a SRAM. The controller 2251 may write data to the NAND flash memory 2252 in response to write commands, or read data from the NAND flash memory 2252 in response to read commands. For example, write and/or read commands may be provided from the processor 2210 within the storage server 2200, the processor 2210m within another storage server 2200m, or the processors 2110 through 2110n of the application servers 2100 through 2100n. A DRAM 2253 may temporarily store (or buffer) data to be written to or read from the NAND flash memory 2252. In some example embodiments, the DRAM 2253 may store metadata. Here, the metadata is user data or data created by the controller 2251 for managing the NAND flash memory 2252. The storage device 2250 may include a secure element (SE) for security or privacy.

While some example embodiments of the present inventive concepts have been described with reference to the attached drawings, it should be understood that the present inventive concepts are not limited thereto. For example, various other forms can be fabricated without changing the technical spirit or essential features of the present inventive concepts. Those skilled in the art in this field will understand that the present inventive concepts can be implemented in other specific forms without departing from the spirit or essential characteristics thereof. Therefore, the example embodiments described are considered in all respects as illustrative and not restrictive.

What is claimed is:

1. A processor, comprising:
a first cache including a first cell array and a first peripheral circuit, the first peripheral circuit being electrically connected to the first cell array; and
a second cache including a second cell array and a second peripheral circuit, the second peripheral circuit being electrically connected to the second cell array and different from the first peripheral circuit, each of the first cell array and the second cell array including magnetic random-access memory (MRAM) cells.

2. The processor of claim 1, wherein the first cache and the second cache have different read speeds.

3. The processor of claim 2, wherein the read speed of the first cache is slower than the read speed of the second cache, and a retention period of the first cache is longer than a retention period of the second cache.

4. The processor of claim 1, wherein the first and second caches are on a same semiconductor chip.

5. The processor of claim 1, further comprising:
a third cache including a third cell array and a third peripheral circuit, the third peripheral circuit being electrically connected to the third cell array and including MRAM cells.

6. The processor of claim 5, wherein the first cache, the second cache, and the third cache have different read speeds.

7. The processor of claim 1, further comprising:
a third cache including a third cell array and a third peripheral circuit, the peripheral circuit being electrically connected to the third cell array and including static random-access memory (SRAM) cells.

8. The processor of claim 1, wherein the first cache or the second cache is configured to store programs for booting.

9. A processor, comprising:
at least one core; and
a cache memory including L1, L2, and L3 caches and a first cache, each of the L3 cache and the first cache including magnetic random-access memory (MRAM) cells, and the at least one core is configured to access the L3 cache before accessing the first cache.

10. The processor of claim 9, wherein the L3 cache and the first cache have different read speeds.

11. The processor of claim 9, wherein the L3 cache and the first cache have different retention periods.

12. The processor of claim 9, wherein each of the L3 cache and the first cache includes a peripheral circuit.

13. The processor of claim 9, wherein the L3 cache and the first cache are on a same semiconductor chip.

14. An electronic device, comprising:
a processor including at least one core and first and second caches, each of the first cache and the second cache including magnetic random-access memory (MRAM) cells and a peripheral circuit; and
a main memory configured to communicate with the processor.

15. The electronic device of claim 14, wherein the processor is on a single semiconductor chip.

16. The electronic device of claim 14, wherein the processor further includes a third cache, the third cache including static random-access memory (SRAM) cells.

17. The electronic device of claim 14, wherein the first and second caches have different retention periods.

18. The electronic device of claim 14, wherein the first and second caches have different read speeds.

19. The electronic device of claim 14, wherein the first cache or the second cache is configured to store programs for booting.

20. The electronic device of claim 14, wherein the processor further includes a third cache, the third cache including MRAM cells.
